(19) United States
(12) Patent Application Publication
(10) Pub. No.: US 2025/0118742 A1
(43) Pub. Date: Apr. 10, 2025

(54) POSITIVE ELECTRODE MATERIAL AND LITHIUM ION SECONDARY BATTERY

(71) Applicant: TOYOTA JIDOSHA KABUSHIKI KAISHA, Toyota-shi (JP)

(72) Inventor: Takahiko NINOMIYA, Miyoshi-shi (JP)

(73) Assignee: TOYOTA JIDOSHA KABUSHIKI KAISHA, Toyota-shi (JP)

(21) Appl. No.: 18/788,570

(22) Filed: Jul. 30, 2024

(30) Foreign Application Priority Data
Oct. 4, 2023 (JP) 2023-173185

(51) Int. Cl. H01M 4/40; H01M 4/02; H01M 10/0525

(52) U.S. Cl. CPC H01M 4/405; H01M 10/0525; H01M 2004/028

(57) ABSTRACT

The disclosure relates to a positive electrode material. The positive electrode material includes a positive electrode active material and two or more kinds of lithium alloys, and the two or more kinds of lithium alloys each include a metallic element having a lithium-alloying potential of 0.5 V (vs. Li/Li⁺) or more.

### CROSS-REFERENCE TO RELATED APPLICATION

This application claims priority to Japanese Patent Application No. 2023-173185 filed on Oct. 4, 2023, incorporated herein by reference in its entirety.

### BACKGROUND

### 1. Technical Field

The present disclosure relates to a positive electrode material and a lithium ion secondary battery.

### 2. Description of Related Art

In a lithium ion secondary battery, a part of lithium ions released from a positive electrode active material during initial charging reacts with an electrolyte on a surface of a negative electrode to form a coating film called solid electrolyte interphase (SEI). It is desirable that the amount of lithium ions to be consumed along with the formation of SEI should be as small as possible, since the consumption of lithium ions causes a reduction in the battery capacity. Measures have been proposed for suppressing the consumption of lithium ions associated with the formation of SEI. Examples of the measures include causing a positive electrode to contain a lithium alloy together with a positive electrode active material, and complementing the amount of lithium ions consumed to form SEI with lithium ions released from the lithium alloy during initial charging. See Japanese Unexamined Patent Application Publication No. 2021-520614 (JP 2021-520614 A), for example.

### SUMMARY

In a method of causing a positive electrode to contain a lithium alloy, metal ions derived from the lithium alloy that has lost lithium ions move to a negative electrode side to precipitate, and this precipitate becomes a resistive layer, which may lead to a reduction in the battery capacity. An object of the present disclosure is to provide a positive electrode material that can be used to manufacture a lithium ion secondary battery in which an initial reduction in the battery capacity is suppressed and a reduction in the battery capacity due to repeated charging and discharging is suppressed. Another object of the present disclosure is to provide a lithium ion secondary battery manufactured using the positive electrode material.

The means for addressing the above object includes the following aspects.

1

A positive electrode material including a positive electrode active material and two or more kinds of lithium alloys, in which the two or more kinds of lithium alloys each include a metallic element having a lithium-alloying potential of 0.5 V (vs. Li/Li⁺) or more.

2

The positive electrode material according to 1, in which the metallic element is selected from bismuth, tin, and antimony.

3

The positive electrode material according to 1 or 2, in which at least two kinds of the lithium alloys each include metallic elements having different crystal orientations.

4

The positive electrode material according to any one of claims 1 to 3, in which at least a portion of the positive electrode active material and at least a portion of the lithium alloys form a composite.

5

A lithium ion secondary battery including a positive electrode that includes a positive electrode active material and two or more kinds of metallic elements having a lithium-alloying potential of 0.5 V (vs. Li/Li⁺) or more.

According to an embodiment of the present disclosure, it is possible to provide a positive electrode material that can be used to manufacture a lithium ion secondary battery in which an initial reduction in the battery capacity is suppressed and a reduction in the battery capacity due to repeated charging and discharging is suppressed, and a lithium ion secondary battery manufactured using the positive electrode material.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B. In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples. In the present disclosure, the term “step” is included in the term as long as the intended purpose of the step is achieved, even if it is not clearly distinguishable from other steps as well as independent steps. In the present disclosure, a combination of two or more preferred embodiments is a more preferred embodiment. In the present disclosure, the amount of each component means the total amount of a plurality of substances unless otherwise specified, when a plurality of substances corresponding to each component are present.

### Positive Electrode Material

The positive electrode material of the present disclosure comprises: a positive electrode active material and two or more kinds of lithium alloys, the two or more kinds of lithium alloys each include a metallic element having a lithium-alloying potential of 0.5 V (vs. Li/Li⁺) or more.

As shown in Examples to be described later, in a secondary battery manufactured using the positive electrode material of the present disclosure, even if a lithium alloy is contained in the positive electrode, a decrease in battery capacity due to repetition of charge and discharge is suppressed. The reason for this may be, for example, that the growth direction of dendrites composed of two or more kinds of metallic elements derived from a lithium alloy generated in the negative electrode is more likely to diffuse than dendrites composed of a single kind of metallic elements, and the growth rate of the dendrites is slow. The suppression of the growth rate of the dendrite is also effective in preventing the dendrite from breaking through the separator and causing a short circuit.

### Lithium Alloy

The lithium alloy includes a metallic element having a lithium-alloying potential of 0.5 V (vs. Li/Li⁺) or more. When the metallic element contained in the lithium alloy has the alloying potential described above, the reduction in the amount of lithium ions released from the positive electrode active material and consumed in forming SEI during the first charge of the batteries is effectively compensated. As a result, a decrease in the initial battery capacity is effectively suppressed. Examples of the metallic element having a lithium-alloying potential of 0.5 V (vs. Li/Li⁺) or more include bismuth, tin, and antimony. The alloying potential of bismuth (Bi) is from 0.81 V to 0.83 V. The alloying potential of tin (Sn) is from 0.57 V to 0.66 V. The alloying potential of antimony (Sb) is from 0.94 V to 0.96 V.

The combination of two or more kinds of lithium alloys included in the positive electrode material includes a combination of a lithium alloy containing Bi (hereinafter, also referred to as a Li—Bi alloy) and a lithium alloy containing Sb (hereinafter, also referred to as a Li—Sb alloy). The combination of two or more kinds of lithium alloys included in the positive electrode material includes a combination of a Li—Bi alloy and a lithium alloy containing Sn (hereinafter, also referred to as a Li—Sn alloy). Further, the combination of two or more kinds of lithium alloys included in the positive electrode material includes a combination of a Li—Bi alloy, a Li—Sb alloy, and a Li—Sn alloy.

Specific examples of Li—Bi include Li₃Bi. Specific examples of Li—Sb include Li₃Sb. Specific examples of Li—Sn include LiSn.

The positive electrode material preferably includes a Li—Bi alloy and at least one of a Li—Sb alloy and a Li—Sn alloy as two or more kinds of lithium alloys, and more preferably includes at least a Li—Bi alloy and a Li—Sb alloy. From the viewpoint of diffusing the growth direction of the dendrites, a lithium alloy containing metallic elements having different crystal orientations may be combined. The crystal orientation of Bi is trigonal, the crystal orientation of Sn is tetragonal (cubic), and the crystal orientation of Sn is trigonal.

From the viewpoint of sufficiently complementing the lithium-ion consumption associated with the formation of SEI, the total content of the two or more kinds of lithium alloys contained in the positive electrode material is preferably 1 part by mass or more with respect to 100 parts by mass of the positive electrode active material. From the viewpoint of sufficiently complementing the lithium-ion consumption associated with the formation of SEI, the total content of the two or more kinds of lithium alloys contained in the positive electrode material is more preferably 2 parts by mass or more. From the viewpoint of sufficiently complementing the lithium-ion consumption associated with the formation of SEI, the total content of the two or more kinds of lithium alloys contained in the positive electrode material is more preferably 5 parts by mass or more. From the viewpoint of ensuring sufficient energy density, the total content of two or more kinds of lithium alloys contained in the positive electrode material is preferably 30 parts by mass or less with respect to 100 parts by mass of the positive electrode active material. From the viewpoint of ensuring sufficient energy density, the total content of the two or more kinds of lithium alloys contained in the positive electrode material is more preferably 20 parts by mass or less, and still more preferably 10 parts by mass or less.

The proportion of each lithium alloy in the two or more kinds of lithium alloys is preferably, for example, the content of the lithium alloy having the smallest content of the entire lithium alloy is preferably 10 mass % or more. The proportion of each lithium alloy in the two or more kinds of lithium alloys is, for example, the content of the lithium alloy having the smallest content among the entire lithium alloy is more preferably 15 mass % or more, and still more preferably 20 mass % or more.

The lithium alloy may be in particulate form. The volume average particle diameter of the lithium alloy in a particulate form is not particularly limited, and can be selected from, for example, a range of 1 μm to 50 μm.

The volume-average particle size of the particles is a D50 when the cumulative volume is 50% in the volume-based particle size distribution measured by the laser diffractometry and scattering method.

### Positive Electrode Active Material

Examples of the positive electrode active material included in the positive electrode material include a composite oxide of lithium and a transition metal (hereinafter, also referred to as a lithium transition metal composite oxide). Examples of the transition-metal include Ni, Co, Mn, Al, B, Mg, Ti, V, Cr, Fe, Cu, Zn, Ga, Sr, Zr, Nb, In, Sn, Ta, and W. Examples of the lithium transition metal composite oxide include a layered lithium transition metal composite oxide, a spinel-type lithium transition metal composite oxide, and an olivine-type lithium transition metal composite oxide. Specific examples of a layer of lithium composite oxide include LiCoO₂, LiNiO₂, LiMnO₂, LiNiₐCo_{b}Mn_{c}O₂ (a+b+c=1), and LiNiₐCo_{b}Mn_{c}M_{d}O₂. In LiNiₐCo_{b}Mn_{c}M_{d}O₂, a+b+c+d=1 holds. Also, in LiNiₐCo_{b}Mn_{c}M_{d}O₂, M is one or more additive elements selected from Al, Mg, La, Ti, Zn, B, W, Fe, Cr, V, Ru, Cu, Cd, Ag, Y, Sc, Ga, In, As, Sb, Pt, Au, Si, and the like. Specific examples of the spinel-type lithium complex oxide include a LiMn₂O₄. Specific examples of the olivine-type lithium complex oxide include LiMPO₄ (M: Fe, Co, Ni or Mn). The positive electrode active material contained in the positive electrode material may be one kind alone or two or more kinds thereof.

Among the lithium composite oxides, a lithium transition metal composite oxide containing at least one selected from Ni, Co and Mn as a transition metal is more preferable. Further, among the lithium composite oxides, a lithium transition metal composite oxide containing Ni as a transition metal and at least one selected from Co and Mn is more preferable. Among the lithium composite oxides, a lithium transition metal composite oxide (NCM, nickel cobalt manganese oxide) containing Ni, Co and Mn as transition metals is more preferable. The molar ratio of Ni, Co and Mn contained in NCM may be selected, for example, from the molar ratio (Ni:Co) of Ni to Co in the range of 1:0.1 to 1:1, and the molar ratio (Ni:Mn) of Ni to Mn in the range of 1:0.1 to 1:1.

The positive electrode active material may be in particulate form. The volume average particle diameter of the positive electrode active material in a particulate form is not particularly limited, and can be selected from, for example, a range of 5 μm to 30 μm. When the positive electrode active material is a secondary particle that is an aggregate of a plurality of primary particles, the volume average particle diameter is the volume average particle diameter of the secondary particles. The positive electrode active material contained in the positive electrode material may be one kind alone or two or more kinds thereof. The volume average particle diameter of the positive electrode active material particles is not particularly limited, and can be selected, for example, from the range of 5 μm to 30 μm.

### Other Ingredients

The positive electrode material may be in a state of a mixture containing components other than the positive electrode active material and the lithium alloy, such as a conductive auxiliary agent and a binder. If desired, a solvent may be added to the mixture to adjust the viscosity of the mixture.

Specific examples of the conductive aid include carbon materials such as carbon black (acetylene black, thermal black, furnace black, and the like), carbon nanotubes, and graphite. The conductive material contained in the positive electrode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, and polymethacrylate. The binder contained in the positive electrode material may be one kind alone or two or more kinds thereof.

### Method for Producing Positive Electrode Material

From the viewpoint of suppressing the movement of the metal ions derived from the lithium alloy contained in the positive electrode material toward the negative electrode side, the method for producing the positive electrode material preferably includes a step of heating a mixture of the positive electrode active material and two or more kinds of lithium alloys at a temperature of 350° C. or higher. The step of heating the mixture of the positive electrode active material and two or more kinds of lithium alloys at a temperature of 350° C. or higher is hereinafter also referred to as an annealing treatment. That is, an embodiment of the present disclosure includes: obtaining a mixture comprising a positive electrode active material and two or more lithium alloys; the method for producing a positive electrode material includes a step of heating the mixture at a temperature of 350° C. or higher.

A secondary battery manufactured using a positive electrode material obtained by performing an annealing treatment of a mixture of a positive electrode active material and two or more kinds of lithium alloys has a better battery capacity than a secondary battery manufactured using a positive electrode material obtained without performing an annealing treatment of the mixture. This is illustrated in the examples described below. As a factor for this, it is conceivable that solid solution diffusion between the positive electrode active material and the lithium alloy occurs by annealing the mixture to form a composite. It is considered that the movement of the metal ions derived from the lithium alloy toward the negative electrode side is suppressed by the state in which the lithium alloy is incorporated into the composite.

The temperature of the annealing treatment is not particularly limited as long as it is 350° C. or more, and may be 450° C. or more, 550° C. or more, or 650° C. or more. The temperature of the annealing treatment may be 1000° C. or less, 900° C. or less, or 800° C. or less. The annealing time is not particularly limited, and may be selected from 30 minutes to 5 hours. The annealing treatment is preferably performed in an inert atmosphere such as nitrogen or argon. The mixture after the annealing treatment is preferably in a state in which at least a part of the positive electrode active material and at least a part of the lithium alloy form a composite (solid solution or the like).

The mixture after the annealing treatment may be subjected to a crushing treatment to form particles. The volume average particle diameter of the particles obtained by crushing the mixture after the annealing treatment can be selected from, for example, a range of 5 μm to 30 μm. The mixture after the annealing treatment may be further mixed with components such as a conductive aid and a binder.

### Positive Electrode

The positive electrode material of the present disclosure is used as a material of a positive electrode of a lithium ion secondary battery. The positive electrode includes, for example, a current collector and a positive electrode layer disposed on the current collector, and the positive electrode layer includes the positive electrode material of the present disclosure. The positive electrode layer may be disposed on one side or both sides of the current collector.

Examples of the material constituting the current collector of the positive electrode include aluminum, an aluminum alloy, nickel, titanium, and stainless steel. Examples of the shape of the current collector include a foil and a mesh.

The positive electrode layer is disposed on the current collector by, for example, applying a slurry-like positive electrode material to one or both surfaces of the current collector. If necessary, a pressure treatment for adjusting the density of the positive electrode layer may be performed. The thickness of the positive electrode layer is not particularly limited, and can be selected from, for example, a range of 10 μm to 100 μm.

### Lithium Ion Secondary Battery

The lithium ion secondary battery of the present disclosure includes a positive electrode that includes a positive electrode active material and two or more kinds of metallic elements having a lithium-alloying potential of 0.5 V (vs. Li/Li⁺) or more.

The two or more kinds of metallic elements included in the positive electrode may be in a state of a single metal or a state of a lithium alloy. At least a part of two or more kinds of metallic elements included in the positive electrode may be in a state of forming a composite together with the positive electrode active material. Details and preferred aspects of the positive electrode active material and the two or more metallic elements included in the positive electrode are the same as the details and preferred aspects of the positive electrode active material and the two or more metallic elements included in the positive electrode material described above.

The positive electrode in the lithium ion secondary battery of the present disclosure may be obtained by using the positive electrode material of the present disclosure described above. Whether or not the positive electrode of the lithium ion secondary battery is obtained by using the positive electrode material of the present disclosure can be confirmed, for example, by taking out the negative electrode from the lithium ion secondary battery after charging and discharging, and whether or not a precipitate of a metallic element contained in the positive electrode material is present in the negative electrode. When a deposit derived from a metallic element contained in the lithium alloy used in the positive electrode material of the present disclosure is present in the negative electrode, it can be determined that the positive electrode of the battery was obtained using the positive electrode material of the present disclosure.

The lithium ion secondary battery of the present disclosure includes, for example, a positive electrode, a negative electrode, a separator disposed between the positive electrode and the negative electrode, and an electrolyte. The negative electrode includes, for example, a current collector and a negative electrode layer disposed on the current collector and including a negative electrode active material. Examples of the negative electrode active material include carbon materials such as graphite, hard carbon, soft carbon, and activated carbon, silicon, metallic lithium, lithium alloy, and lithium titanate (LTO). Examples of the material constituting the current collector of the negative electrode include copper, a copper alloy, nickel, titanium, and stainless steel. Examples of the shape of the current collector of the negative electrode include a foil and a mesh. Examples of the separator include a nonwoven fabric, a cloth, and a microporous film containing a polyolefin as a main component, such as polyethylene and polypropylene. The electrolyte may be either a liquid or a solid. As the liquid electrolyte (electrolytic solution), a solution obtained by dissolving a known electrolyte such as LiPF₆ in an organic solvent can be used without any particular limitation. As the solid electrolyte, a known solid electrolyte such as a sulfide solid electrolyte, an oxide solid electrolyte, or a halide solid electrolyte can be used without any particular limitation.

Hereinafter, the present disclosure will be described in more detail with reference to Examples, but the disclosure of the present disclosure is not limited to these Examples.

### Preparation of Evaluation Battery

NCM (LiNi_{0.8}Co_{0.1}Mn_{0.1}O₂) as a positive electrode active material and LiB₃, Li₃Sb and LiSn as lithium alloy that are in the amount shown in Table 1 were used in the preparation of the batteries of the respective Examples. The amount of each component was adjusted so that the total volume of the positive electrode active material and the lithium alloy was equal in each example.

In Examples 1 to 3, the mixture of the positive electrode active material and the lithium alloy shown in Table 1 was annealed in a nitrogen atmosphere at 700° C. for 2 hours, and then subjected to a crushing treatment to obtain composite particles of the positive electrode active material and the lithium alloy. In Examples 4 and 5 and Comparative Examples 1 to 3, no annealing treatment was performed on the mixture of the positive electrode active material and the lithium alloy shown in Table 1.

A slurry-like positive electrode material was obtained by mixing a mixture (93 g) of a positive electrode active material and a lithium alloy, carbon black (4 g) as a conductive auxiliary agent, PVDF (3 g) as a binder, and a solvent (NMP). The obtained positive electrode material was coated on an aluminum foil and dried to obtain a positive electrode. A laminate type evaluation battery was produced using the obtained positive electrode, separator (polyethylene microporous film), and an electrode body formed by laminating negative electrodes containing graphite as an active material in this order, and an electrolytic solution. The electrolytic solution is a mixed solvent of ethylene carbonate/dimethyl carbonate/ethyl methyl carbonate containing LiPF₆ as an electrolyte.

### Evaluation of Battery Performance

210 mA/g current was defined as 1 C rate based on the mass of the positive electrode active material contained in the cell, and CCCV charge and CCCV discharge were performed under the following conditions. The obtained CCCV capacity was defined as the capacity of the cell (initial discharging capacity).
Lower limit: 2.5 V
Upper limit: 4.25 V
Charge/discharge current: 0.2 C
Termination current: 0.03 C

Thereafter, cycling tests (CC charge and CC discharging) of the batteries were performed. Table 1 shows the number of cycles when CC discharge capacity of the batteries reaches 40% or less of the initial discharge capacity. As the number of cycles shown in Table 1 increases, it can be determined that a decrease in battery capacity due to repetition of charging and discharging is further suppressed.

TABLE 1

| | Positive | | | | | | | | | |
|---|---|---|---|---|---|---|---|---|---|---|
| | electrode | | | | | | | | | |
| | active material | | Li Alloy 1 | | | Li Alloy 2 | | | Total | Number |
| | Mass | Volume | Alloy | Mass | Volume | Alloy | Mass | Volume | Volume | of |
| | (mg) | (cm³) | type | (mg) | (cm³) | type | (mg) | (cm³) | (cm³) | cycles |
| Example 1 | 92.6 | 0.0201 | Li₃Bi | 4.2 | 0.00085 | Li₃Sb | 2.6 | 0.00075 | 0.0217 | 81 |
| Example 2 | 89.9 | 0.0195 | Li₃Bi | 4.2 | 0.00085 | LiSn | 6.9 | 0.00135 | 0.0217 | 73 |
| Example 3 | 90.3 | 0.0196 | Li₃Sb | 2.6 | 0.00075 | LiSn | 6.9 | 0.00135 | 0.0217 | 60 |
| Example 4 | 92.6 | 0.0201 | Li₃Bi | 4.2 | 0.00085 | Li₃Sb | 2.6 | 0.00075 | 0.0217 | 41 |
| Example 5 | 89.9 | 0.0195 | Li₃Bi | 4.2 | 0.00085 | LiSn | 6.9 | 0.00135 | 0.0217 | 42 |
| Comparative | 92.3 | 0.0200 | Li₃Bi | 8.4 | 0.0017 | — | — | — | 0.0217 | 26 |
| Example 1 | | | | | | | | | | |
| Comparative | 92.8 | 0.0202 | Li₃Sb | 5.2 | 0.0015 | — | — | — | 0.0217 | 26 |
| Example 2 | | | | | | | | | | |
| Comparative | 87.3 | 0.0190 | LiSn | 13.8 | 0.0027 | — | — | — | 0.0217 | 24 |
| Example 3 | | | | | | | | | | |

As shown in Table 1, the batteries of Examples 1 to 5 in which two kinds of lithium alloys were used as the material of the positive electrode showed an excellent capacity retention ratio as compared with the batteries of Comparative Examples 1 to 3 in which one kind of lithium alloy was used as the material of the positive electrode. Among Examples 1 to 5, Examples 1 to 3 in which the annealing treatment was performed on the mixture of the positive electrode active material and the lithium alloy showed a capacity retention ratio superior to that of Examples 4 and 5 in which the annealing treatment was not performed on the mixture of the positive electrode active material and the lithium alloy. Among Examples 1 to 3, the batteries of Example 1 using a lithium alloy containing Bi and a lithium alloy containing Sb exhibited particularly excellent capacity retention. For this reason, it is conceivable that, for example, a combination of Bi and Sb exhibits a topological insulator-like behavior, and ionization of bulk is suppressed.

Evaluation of Metal Ion Release from Lithium Alloys

The cell after the cycle test was disassembled, and the positive electrode was taken out. Sample solutions were prepared from the positive electrode layers using an acid. Elemental analysis was performed by ICP-AES (ICP emission spectroscopy). The concentration of the metallic element in the lithium alloy used in the preparation of the positive electrode is shown in Table 2 as a ratio when the initial concentration is 100.

TABLE 2

| | Li Alloy 1 | | Li Alloy 2 | |
|---|---|---|---|---|
| | Element | Residual rate | Element | Residual rate |
| Example 1 | Bi | 83 | Sb | 80 |
| Example 2 | Bi | 82 | Sn | 78 |
| Example 3 | Sb | 81 | Sn | 76 |
| Example 4 | Bi | 45 | Sb | 40 |
| Example 5 | Bi | 48 | Sn | 35 |
| Comparative | Bi | 46 | — | — |
| Example 1 | | | | |
| Comparative | Sb | 38 | — | — |
| Example 2 | | | | |
| Comparative | Sn | 32 | — | — |
| Example 3 | | | | |

As shown in Table 2, in Examples 1 to 3, the residual rate of the metallic element derived from the lithium alloy in the positive electrode was higher than in Examples 4 and 5 and Comparative Examples 1 to 3. In Examples 1 to 3, the mixture of the positive electrode active material and the lithium alloy was annealed. In Examples 4 and 5 and Comparative Examples 1 to 3, the annealing treatment is not performed on the mixture of the positive electrode active material and the lithium alloy. The above results suggest that by performing an annealing treatment on the mixture of the positive electrode active material and the lithium alloy, the movement of the metallic element derived from the lithium alloy toward the negative electrode side is effectively suppressed.

What is claimed is:

1. A positive electrode material comprising a positive electrode active material and two or more kinds of lithium alloys, wherein the two or more kinds of lithium alloys each include a metallic element having a lithium-alloying potential of 0.5 V (vs. Li/Li⁺) or more.

2. The positive electrode material according to claim 1, wherein the metallic element is selected from bismuth, tin, and antimony.

3. The positive electrode material according to claim 1, wherein at least two kinds of the lithium alloys each include metallic elements having different crystal orientations.

4. The positive electrode material according to claim 1, wherein at least a portion of the positive electrode active material and at least a portion of the lithium alloys form a composite.

5. A lithium ion secondary battery comprising a positive electrode that includes a positive electrode active material and two or more kinds of metallic elements having a lithium-alloying potential of 0.5 V (vs. Li/Li⁺) or more.
